(19) United States
(12) Patent Application Publication
(10) Pub. No.: US 2026/0116378 A1
(43) Pub. Date: Apr. 30, 2026

(54) AUTOMATIC PARKING SYSTEM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Shinichiro SAKAI, Tokyo (JP); Yusuke KIYOKAWA, Tokyo (JP)

(21) Appl. No.: 19/409,330

(22) Filed: Dec. 4, 2025

Related U.S. Application Data
(63) Continuation of application No. PCT/JP2024/019716, filed on May 29, 2024.

(30) Foreign Application Priority Data
Jun. 6, 2023 (JP) 2023-092858

(51) Int. Cl. B60W 30/06; B60W 50/00

(52) U.S. Cl. CPC B60W 30/06; B60W 50/00; B60W 2050/0083; B60W 2540/18; B60W 2556/50

(57) ABSTRACT

In an automatic parking system, a vehicle state detection unit detects a traveling state of the vehicle. The traveling state including at least a position of the vehicle and a steering angle of the vehicle. A reference route storage unit stores a reference route that is comprised of multiple waypoints at each of which a corresponding traveling state of the vehicle detected during traveling of the vehicle by a driver's driving to a target point is associated. A parking route setting unit sets a parking route from an automatic parking start point to the target point using at least one waypoint included in the multiple waypoints as a temporary merge point to the reference route. The at least one waypoint is at least one neutral point at which a steering angle of the vehicle is neutral. A vehicle control unit controls the vehicle so as to cause the vehicle to travel along the parking route.

### CROSS-REFERENCE TO RELATED APPLICATION

This present application is a bypass continuation application of currently pending international application No. PCT/JP2024/019716 filed on May 29, 2024 designating the United States of America, the entire disclosure of which is incorporated herein by reference, the international application being based on and claiming the benefit of priority from Japanese Patent Application No. 2023-092858 filed on Jun. 6, 2023, the disclosure of which is incorporated herein by reference.

### TECHNICAL FIELD

The present disclosure relates to automatic parking systems.

### BACKGROUND

Automatic parking systems are known in which a vehicle is automatically driven along a parking route that is set to follow a reference route recorded as a driver's previously-traveled route when parking into a parking space. The driver assistance method disclosed in Japanese Patent Application Publication No. 2013-530867 determines a merge point to the reference route such that a vehicle's heading angle relative to the reference route becomes smaller than a preset angle, and causes the vehicle to travel toward the merge point.

### SUMMARY

Such a conventional driver assistance method of determining a merge point of a vehicle to a reference route only by the vehicle's heading angle relative to the reference route may result in a steering angle of the vehicle remaining relatively large although the heading angle is smaller than the present angle. This may therefore result in the traveling condition of the vehicle becoming unstable.

There may be a large difference between the start position of the vehicle for parking assistance and the reference route depending on the vehicle's start position, making it difficult to determine a merge point that enables the heading angle of the vehicle to be smaller than the preset angle.

The present disclosure can be achieved as exemplary aspects described hereinafter.

A first exemplary aspect of the present disclosure provides an automatic parking system for parking an automatically traveling vehicle. The automatic parking system includes a vehicle state detection unit configured to detect a traveling state of the vehicle, the traveling state including at least a position of the vehicle and a steering angle of the vehicle, and a reference route storage unit configured to store a reference route that is comprised of multiple waypoints at each of which a corresponding traveling state of the vehicle detected during traveling of the vehicle by a driver's driving to a target point is associated. The automatic parking system includes a parking route setting unit configured to set a parking route from an automatic parking start point to the target point using at least one waypoint included in the multiple waypoints as a temporary merge point to the reference route. The at least one waypoint being at least one neutral point at which a steering angle of the vehicle is neutral. The automatic parking system includes a vehicle control unit configured to control the vehicle so as to cause the vehicle to travel along the parking route.

The parking route setting unit of the automatic parking system according to the first exemplary aspect is configured to set the parking route using the at least one waypoint as the temporary merge point to the reference route. The at least one waypoint is at least one neutral point at which the steering angle of the vehicle is neutral.

This configuration enables the vehicle to merge into the reference route through the at least one neutral point with a neutral steering angle.

Compared with a configuration that determines a merge point into the reference route solely by the vehicle's heading angle relative to the reference route, this configuration of the automatic parking system according to the first exemplary aspect makes it possible to suppress destabilization of vehicle motion during parking.

Additionally, compared with a configuration that sets, as the temporary merge point, a waypoint with a leftward or rightward steering angle, this configuration of the automatic parking system according to the first exemplary aspect enables the vehicle, which has reached the temporary merge point on the reference route, to easily steer in either left or right direction, making it possible to suppress restriction of the traveling direction of the vehicle on the subsequent portion of the parking route from the temporary merge point.

A second exemplary aspect of the present disclosure provides an automatic parking system for parking an automatically traveling vehicle. The automatic parking system of the second exemplary aspect includes a vehicle state detection unit configured to detect a traveling state of the vehicle, the traveling state including at least a position of the vehicle and a steering angle of the vehicle. The automatic parking system includes a reference route storage unit configured to store a reference route that is comprised of multiple waypoints at each of which a corresponding traveling state of the vehicle detected during traveling of the vehicle by a driver's driving to a target point is associated. The multiple waypoints include a first waypoint, a second waypoint, and a third waypoint. The first, second, and third waypoints are different from one another. The second waypoint is located closer to the vehicle than the first waypoint is.

The automatic parking system of the second exemplary aspect includes a parking route setting unit configured to set a parking route from an automatic parking start point to the target point using the first waypoint as a temporary merge point to the reference route. The first waypoint is a neutral point at which a steering angle of the vehicle is neutral. The parking route is arranged to merge the reference route at the first waypoint as the temporary merge point.

The automatic parking system of the second exemplary aspect includes a vehicle control unit configured to control the vehicle so as to cause the vehicle to travel along the parking route.

The parking route setting unit is configured to determine whether a difference between (i) the parking route set using the first waypoint as the temporary merge point to the reference route and (ii) the reference route is greater than or equal to a threshold distance. The parking route setting unit is configured to reset the parking route using the second waypoint or the third waypoint as the temporary merge point to the reference route in response to determination that the difference between (i) the parking route set using the first waypoint as the temporary merge point to the reference route and (ii) the reference route is greater than or equal to the threshold distance.

The parking route setting unit of the automatic parking system according to the second exemplary aspect is configured to reset the parking route using the second waypoint or the third waypoint as the temporary merge point to the reference route in response to determination that the difference between (i) the parking route set using the first waypoint as the temporary merge point to the reference route and (ii) the reference route is greater than or equal to the threshold distance. This configuration therefore enables the vehicle to merge earlier into the reference route from the automatic parking start point of the vehicle, and makes the parking route with a smaller difference from the reference route likely to be set.

### BRIEF DESCRIPTION OF THE DRAWINGS

Other aspects of the present disclosure will become apparent from the following description of embodiments with reference to the accompanying drawings in which:

FIG. 1 is a block diagram illustrating a schematic configuration of an automatic parking system according to an exemplary embodiment;

FIG. 2 is a flowchart illustrating a first part of a parking route setting routine according to the exemplary embodiment;

FIG. 3 is a flowchart illustrating a second part of the parking route setting routine according to the exemplary embodiment;

FIG. 4 is a flowchart illustrating a third part of the parking route setting routine according to the exemplary embodiment;

FIG. 5 is a flowchart illustrating a reference-point selection routine according to the exemplary embodiment; and

FIG. 6 is an explanatory diagram illustrating an example of a reference route and a parking route.

### DETAILED DESCRIPTION OF EMBODIMENTS

### Exemplary Embodiment

### System Configuration

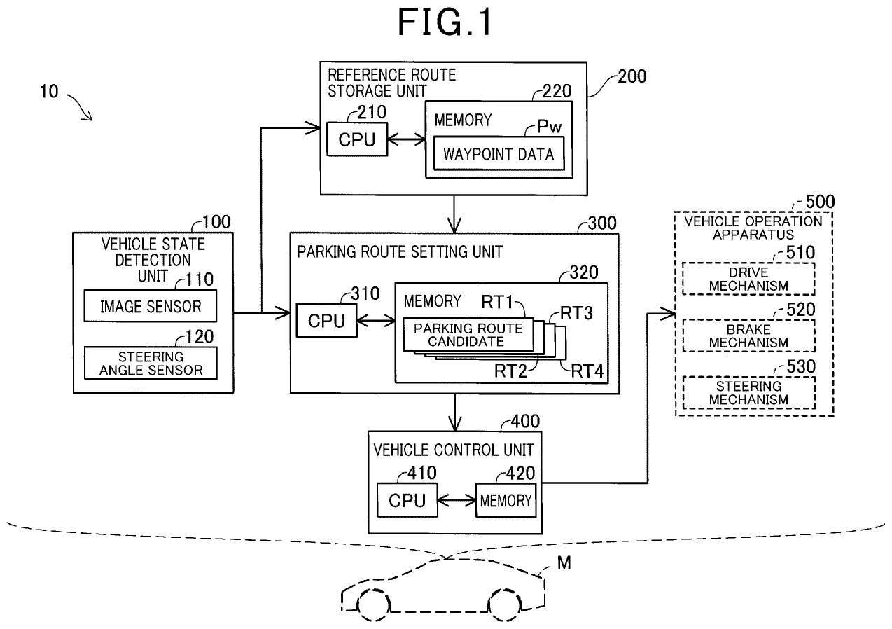

An automatic parking system 10 of an exemplary embodiment is installed in a vehicle M, and is configured to automatically drive the vehicle M according to the vehicle's traveling state and surrounding environments around the vehicle M, thereby assisting parking of the vehicle M. As shown in FIG. 1, the automatic parking system 10 includes a vehicle state detection unit 100, a reference route storage unit 200, a parking route setting unit 300, and a vehicle control unit 400.

The vehicle state detection unit 100 detects the traveling state of the vehicle M. The traveling state of the vehicle M includes at least the current position of the vehicle M and the steering angle of the vehicle M at the current position thereof.

The automatic parking system 10 of the exemplary embodiment includes, as the vehicle state detection unit 100, one or more image sensors 110 and a steering angle sensor 120.

The one or more image sensors 110 are mounted to the vehicle M to capture, for example, images of front-view, rear-view, left-view, and right-view of the vehicle M. The one or more image sensors 110 acquires captured images of objects and markers (also referred to as “reference landmarks”) around the vehicle M. In the exemplary embodiment, the reference landmarks are objects existing around the vehicle M that can serve as positional references in the captured images.

The steering angle sensor 120 (which may include one or more sensors) measures the steering angle of the steerable wheels of the vehicle M.

The automatic parking system 10 may further include, as part of the vehicle state detection unit 100, various sensors such as a millimeter-wave radar, an ultrasonic sensor, and LiDAR (Light Detection And Ranging) for detecting landmarks around the vehicle M; a GNSS receiver that receives navigation signals from satellites constituting a Global Navigation Satellite System (GNSS) to detect the current position (longitude and latitude) of the vehicle M; and a vehicle speed sensor that detects the speed of the vehicle M.

The reference route storage unit 200 of the exemplary embodiment is implemented as an ECU (Electronic Control Unit) including a CPU 210 and a memory 220. The reference route storage unit 200 stores a reference route. The term “reference route” means a traveling route of the vehicle M when the vehicle M travels a section from an arbitrary starting point to a target point under driver's driving of the vehicle M; the section is also referred to as a “learning section”.

The reference route is comprised of multiple waypoints at each of which the traveling state of the vehicle M along the learning section is to be detected.

The starting point of the reference route may be set to the position of the vehicle M at the time when the start of a learning mode is instructed by a driver's button operation. The target point may be set to the position of the vehicle M at the time when the termination of the learning mode is instructed by a driver's button operation.

If an upper limit of the route length that can be stored as the reference route is predetermined, the target point is set to the position of the vehicle M when the route length from the starting point reaches the upper limit.

The reference route storage unit 200 stores, as a waypoint data item Pw for each waypoint in the memory 220, the vehicle state obtained by the vehicle state detection unit 100 each time the vehicle M travels by a predetermined distance to reach the corresponding waypoint.

More specifically, the reference route storage unit 200 analyzes captured images for each waypoint obtained from the one or more image sensors 110 each time the vehicle travels by the predetermined distance to reach the corresponding waypoint to thereby capture the position of the vehicle M with reference to one or more reference landmarks existing around the corresponding waypoint, and stores the calculated vehicle position of the vehicle M as the waypoint data item Pw for the corresponding waypoint in the memory 220.

The reference route storage unit 200 additionally acquires the steering angle of the vehicle M at each waypoint from the steering angle sensor 120 each time the vehicle M travels by the predetermined distance to reach the corresponding waypoint and stores the acquired angle of the vehicle M as the waypoint data Pw for the corresponding waypoint in the memory 220.

The waypoint data item Pw for one of the multiple waypoints, which indicates the starting point of the learning section (also referred to simply as the starting point), includes at least (i) the position of the starting point relative to the one or more reference landmarks existing around the starting point and (ii) the steering angle of the vehicle M at the starting point. The waypoint data item Pw for each of the other waypoints following the starting point includes at least the position of the corresponding waypoint relative to the starting point and the steering angle of the vehicle M at the corresponding waypoint.

The parking route setting unit 300 is implemented as an ECU including a CPU 310 and a memory 320. The parking route setting unit 300 sets a parking route from an automatic parking start point to the target point of the above learning section. The automatic parking start point may be any point and need not coincide with the starting point of the above reference route.

The parking route setting unit 300 additionally stores parking route candidates that are set as candidate routes. In FIG. 1, four parking route candidates RT1 to RT4 are illustrated and stored in the memory 320, but the number of parking-route candidates is not limited to four. How to specifically set the parking route of the vehicle M will be described later.

The vehicle control unit 400 is implemented as an ECU including a CPU 410 and a memory 420. The vehicle control unit 400 controls the vehicle operation apparatus 500 so as to drive the vehicle M in accordance with either a driver's operation of the accelerator pedal, brake pedal, and steering wheel, or the parking route set by the parking route setting unit 300.

The vehicle motion device 500 includes a drive mechanism 510, a brake mechanism 520, and a steering mechanism 530.

The drive mechanism 510 outputs driving power to drive the vehicle M. Examples of the drive mechanism 510 include an internal combustion engine and an electric motor. The drive mechanism 510 is electrically connected to the vehicle control unit 400, and the driving power is controlled in accordance with control signals transmitted from the vehicle control unit 400.

The brake mechanism 520 outputs braking force for braking the vehicle M. The brake mechanism 520 is electrically connected to the vehicle control unit 400, and the braking force is controlled in accordance with control signals transmitted from the vehicle control unit 400.

The steering mechanism 530 outputs steering force for steering the vehicle M. The steering mechanism 530 may be, for example, a power steering device. The steering mechanism 530 is electrically connected to the vehicle control unit 400, and the steering force is controlled in accordance with control signals transmitted from the vehicle control unit 400.

### Parking Route Setting Routine

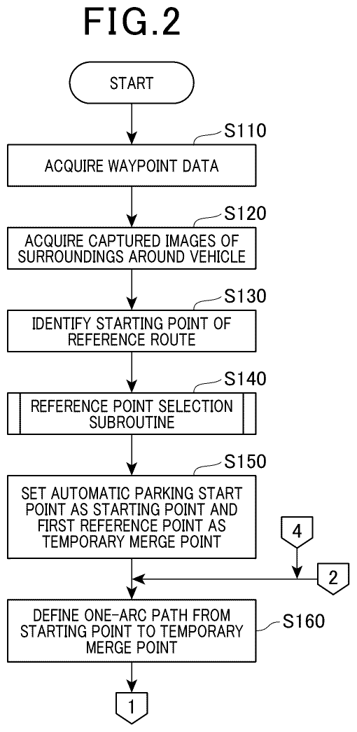

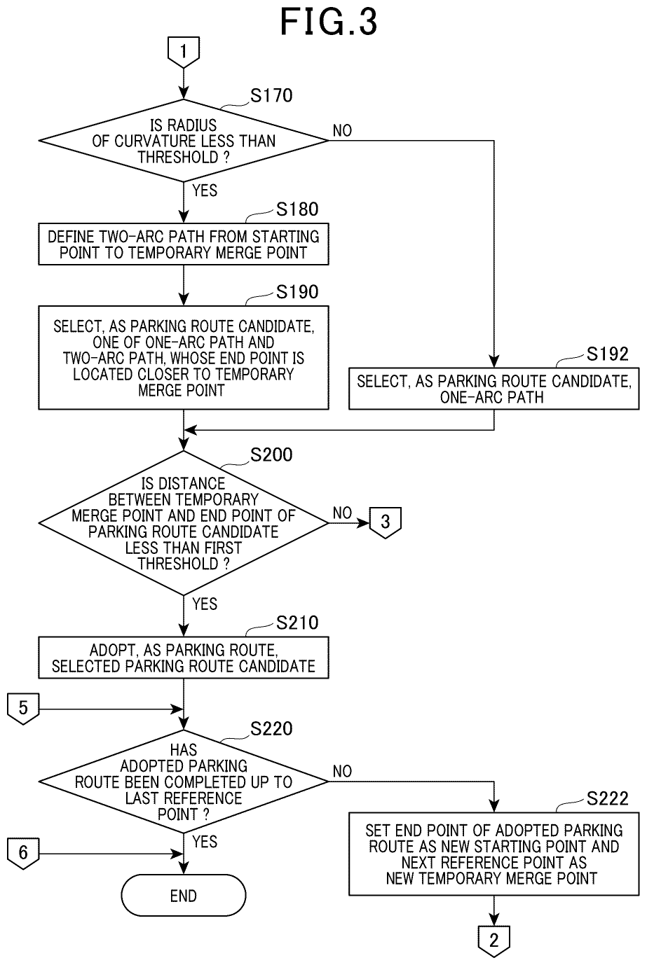

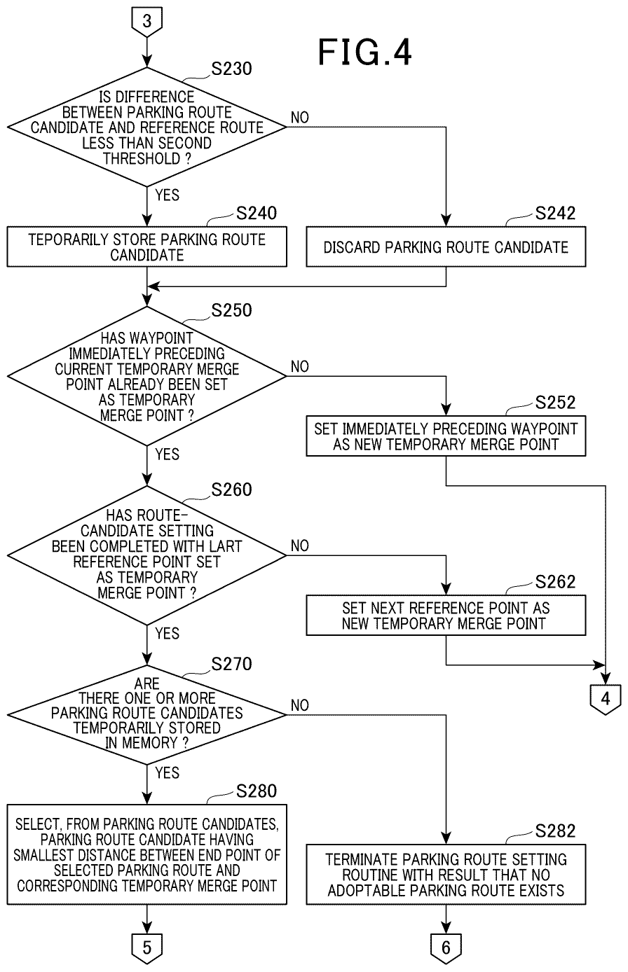

The automatic parking system 10 executes a parking route setting routine is shown in FIGS. 2 to 4 to accordingly set a parking route for the vehicle M.

The parking route is set such that the vehicle M merges from its current position into the reference route and then reaches the learned target point.

The parking route setting routine is configured to start upon the start of the parking route setting routine is instructed by a driver's button operation, for example. When the parking route from the current position of the vehicle M to the learned target point is determined by the parking route setting routine, the automatic parking system 10 controls the vehicle motion device 500 so that the vehicle M travels along the set parking route.

When starting the parking route setting routine, the parking route setting unit 300 acquires the waypoint data items Pw from the reference route storage unit 200 in step S110.

Next, the parking route setting unit 300 acquires captured images of the surroundings around the vehicle M from the vehicle state detection unit 100 in step S120.

Following the operation in step S120, the parking route setting unit 300 identifies one or more reference landmarks included in the captured images in step S130. Then, the parking route setting unit 300 compares the identified one or more reference landmarks with one or more landmarks associated with the starting point of the reference route included in the obtained waypoint data item Pw of the starting point to accordingly determine the position of the starting point of the reference route in step S130.

Specifically, the parking route setting unit 300 specifies the reference landmarks in the captured images, and matching the reference landmarks included in the captured images with the reference landmarks associated with the starting point of the reference route included in the obtained waypoint data item Pw of the starting point to accordingly determine the position of the starting point of the reference route; the reference landmarks serve as positional references for determining the position of the starting point of the reference route. Identification of the one or more reference landmark in the captured images can be achieved by known image processing, such as pattern matching.

Next, the parking route setting unit 300 executes a reference point selection subroutine in step S140 to accordingly select reference points from among the multiple waypoints of the respective waypoint data items Pw. The term “reference point” refers to a waypoint among the multiple waypoints that is preferentially used as a connection target to which the vehicle M attempts to merge the current position into the reference route.

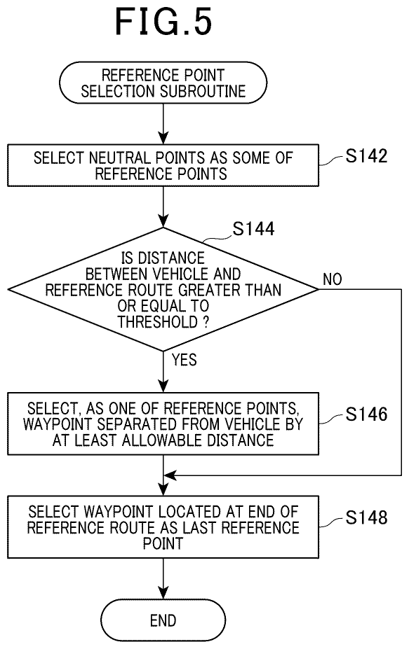

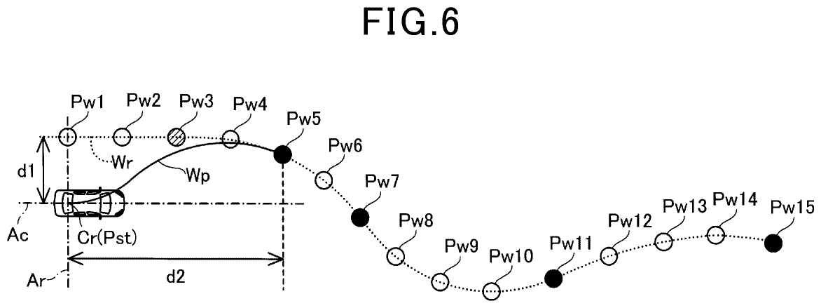

The following describes the reference point selection subroutine in step S140 with reference to FIG. 5 while appropriately referring to an example illustrated in FIG. 6.

In FIG. 6, a reference route Wr comprised of waypoints Pw1 to Pw15 is illustrated. Among the waypoints, waypoints Pw5, Pw7, Pw11, and Pw15 are selected as reference points through the reference point selection subroutine described later, which are indicated by black circles, while the other waypoints are indicated by white circles. Among the white circles, the waypoint Pw3, which is indicated with hatching, will be described later.

In step S142 of FIG. 5, the parking route setting unit 300 selects, as specified points of the reference points, waypoints at each of which the steering angle is neutral, i.e., is in a neutral state, which are also referred to as “one or more neutral point”. On straight portions of the reference route, such reference points are selected at predetermined intervals. In the example of FIG. 6, waypoints Pw7 and Pw11 are selected as the neutral points and thereby serve as the reference points.

Let us consider a comparative configuration that differs from the exemplary embodiment. In the comparative configuration, waypoints having steering angles turned from the neutral of the steering angle to either side are used as the reference points and the vehicle M attempts to merge into the reference route from the current position through one of the reference points. This comparative configuration may result in the following problem occurring.

For example, when the vehicle M merges into the reference route with a waypoint whose steering angle is at the maximum right limit set as the reference point, the vehicle M cannot take a further rightward course after merging, which may restrict the traveling direction in the parking route.

In contrast, the above configuration of the exemplary embodiment in which the vehicle M attempts to merge into the reference route through one of the reference points where the steering angle is neutral makes it possible for the vehicle M to easily take either a leftward or rightward course after merging, thereby preventing limitations in the traveling direction of the vehicle M along the parking route.

Following the operation in step S142, the parking route setting unit 300 determines whether the distance between the vehicle M and the reference route is greater than or equal to a preset threshold in step S144.

As illustrated in FIG. 6, the parking route setting unit 300 calculates, as the distance between the vehicle M and the reference route, a minimum distance d1 along a rear axle Ar from a vehicle reference point Cr to the reference route; the vehicle reference point denotes the intersection of a longitudinal centerline Ac of the vehicle M and the rear axle Ar.

In response to determination that the distance between the vehicle M and the reference route is greater than or equal to the threshold (YES in step S144), the reference point selection subroutine proceeds to step S146.

In step S146, the parking route setting unit 300 selects, as one of the reference points, one of the multiple waypoints on the reference route, which is separated from the vehicle M by at least a predetermined allowable distance.

The “allowable distance” is set based on simulations or other similar methods as a distance from the vehicle M to a waypoint that allows merging of the vehicle M into the reference route without abrupt steering.

Selecting, as one of the reference point, one of the multiple waypoints on the reference route, which is separated from the vehicle M by at least the allowable distance avoids the occurrence of a situation where the vehicle M attempts to merge into the reference route through a closer waypoint thereto with an abrupt steering angle so that motion of the vehicle M becomes unstable. In the example of FIG. 6, the distance d1 is determined to be greater than or equal to the threshold.

Specifically, the parking route setting unit 300 selects, as one of the reference points, one of the multiple waypoints on the reference route whose distance d2 from the vehicle reference point Cr along the direction of the longitudinal centerline Ac is determined to be greater than or equal to the allowable distance.

As illustrated in FIG. 6, the parking route setting unit 300 selects, as one of the reference points, the waypoint Pw5 located at the distance d2 along the longitudinal centerline Ac that is greater than or equal to the allowable distance from the vehicle reference point Cr.

In the example of FIG. 6, the waypoint Pw3 shown with hatching on a straight portion of the route is a neutral point at which the steering angle is neutral; however, a distance of the waypoint Pw3 along the centerline Ac from the vehicle reference point Cr is less than the allowable distance, and therefore the waypoint Pw3 is not selected as one of the reference points. The waypoint Pw3 corresponds to the “closest neutral point” in the present disclosure.

The waypoint Pw5, which is located closer to the automatic parking start point than other reference points, is selected as the reference point closest to the parking start point, and serves as a closet reference point.

In response to determination that the distance between the vehicle M and the reference route is less than the threshold (NO in step S144), the parking route setting unit 300 skips the operation in step S146 and executes the following operation in step S148.

In step S148, the parking route setting unit 300 selects, as the final point in the reference points, one of the multiple waypoints of the reference route located at the end of the reference route. In the example of FIG. 6, the waypoint Pw15, which is located at the end of the reference route Wr, is selected as the last reference point.

Accordingly, the reference points selected in the exemplary embodiment include the closest reference point (Pw5) closest to the parking start point, the intermediate neutral reference points (Pw7 and Pw11), and the last reference point (Pw15) located at the end of the reference route (see FIG. 6).

After selection of the above reference points, the reference point selection subroutine in step S140 is completed, and the parking route setting routine proceeds to step S150 of FIG. 2.

In step S150, the parking route setting unit 300 sets the automatic parking start point of the vehicle M as a starting point and sets the first reference point included in the reference points as a temporary merge point, in other words, a tentative end point, to the reference route. In the example of FIG. 6, the automatic parking start point Pst, which is the vehicle reference point Cr at the start of the parking route setting routine, is set as the starting point, and the waypoint Pw5, i.e., the first reference point, is set as the temporary merge point.

Next, the parking route setting unit 300 defines a one-arc path from the starting point to the temporary merge point in step S160.

The one-arc path is a route that connects the starting point and the temporary merge point by a single circular arc. The one-arc path according to the exemplary embodiment is formed as an arc that is tangent to the reference route at the temporary merge point serving as a tangent point. The end point of the one-arc path set in step S160 need not strictly coincide with the temporary merge point; the one-arc path may extend to a vicinity of the temporary merge point. Because steering of the vehicle M need not change during traveling of the vehicle M along such a one-arc path, such a one-arc path suppresses instability of vehicle motion compared with a two-arc path described later.

Following the operation in step S160, the parking route setting unit 300 determines whether a radius of curvature of the defined one-arc path is less than a predetermined threshold value in step S170.

In response to determination that the radius of curvature of the one-arc path is less than the threshold value (YES in step S170), the parking route setting routine proceeds to step S180.

In step S180, the parking route setting unit 300 defines a two-arc path from the starting point to the temporary merge point.

The two-arc path is a route that connects the starting point and the temporary merge point by two circular arcs.

The two circular arcs constituting the two-arc path according to the exemplary embodiment include a first arc and a second arc. The first arc connects to the starting point, and the second arc connects to the temporary merge point. The second arc is formed as an arc that is tangent to the reference route at the temporary merge point serving as a tangent point. A small radius of curvature in the one-arc path may require a large steering angle and may destabilize vehicle motion, which may be undesirable. The end point of the defined two-arc path need not strictly coincide with the temporary merge point; the two-arc path may extend to a vicinity of the temporary merge point.

FIG. 6 illustrates an example of a part of a parking route Wp defined as a two-arc path connecting the starting point Pst and the temporary merge point Pw5. The part of the parking route Wp has an S-shape formed by two externally tangent circular arcs.

Following the operation in step S180, the parking route setting unit 300 selects, as a parking route candidate, one of the one-arc path and the two-arc path, whose end point is located closer to the temporary merge point in step S190.

Otherwise, in response to determination that the radius of curvature of the one-arc path is more than or equal to the threshold value (NO in step S170), the parking route setting routine proceeds to step S192.

In step S192, the parking route setting unit 300 selects the one-arc path as a parking route candidate.

Following the operation in step S190 or S192, the parking route setting unit 300 determines whether a distance between the temporary merge point and the end point of the parking route candidate is less than a predetermined first threshold in step S200. In response to determination that the distance is less than the first threshold (YES in step S200), the parking route setting routine proceeds to step S210. In step S210, the parking route setting unit 300 adopts, as a parking route of the vehicle M, the parking route candidate selected in step S190.

Following the operation in step S210, the parking route setting unit 300 determines whether the parking route adopted in step S210 has been completed up to the last reference point in step S220.

In response to determination that the parking route has been completed up to the last reference point (YES in step S220), the parking route setting unit 300 terminates the parking route setting routine.

Otherwise, in response to determination that the parking route has not been completed up to the last reference point (NO in step S220), the parking route setting routine proceeds to step S222.

In step S222, the parking route setting unit 300 sets the end point of the adopted parking route as a new starting point and sets the next reference point as a new temporary merge point. In the example of FIG. 6, the next reference point is the waypoint Pw7. As shown in FIG. 2, the parking route setting unit 300 then returns to step S160, and executes the operation in step S160 and subsequent operations.

Otherwise, in response to determination that the distance is greater than or equal to the first threshold (NO in step S200), the parking route setting routine proceeds to step S230.

In step S230, the parking route setting unit 300 determines whether a difference between the parking route candidate and the reference route is less than a second threshold.

The reference route may reflect a driver's intent for parking, for example, avoiding obstacles such as a flowerbed. Adopting a parking route that deviates greatly from the reference route might result in problems such as contacting an obstacle contrary to driver intent. The determination in step S230 aims to address such an issue.

Specifically, the parking route setting unit 300, for example, selects multiple first points on the parking route candidate, which are located at predetermined intervals, and selects, for each first point, a corresponding second point on the reference route along a direction orthogonal to the parking route candidate. Then, the parking route setting unit 300 calculates a distance between each first point and the corresponding second point on the reference route, and determines an average of the distances between the respective first points and the corresponding second points as a measure of the difference between the parking route candidate and the reference route.

In response to determination that the difference between the parking route candidate and the reference route is less than the second threshold (YES in step S230), the parking route setting routine proceeds to step S240.

In step S240, the parking route setting unit 300 temporarily stores the parking route candidate in the memory 320.

Otherwise, in response to determination that the difference between the parking route candidate and the reference route is greater than or equal to the second threshold (NO in step S230), the parking route setting unit 300 discards the parking route candidate and does not temporarily store it in the memory 320 in step S242.

Following the operation in step S240 or S242, the parking route setting unit 300 determines whether the waypoint immediately preceding the current temporary merge point has already been set as a temporary merge point or no such preceding waypoint exists, in which case the route-candidate setting for the starting point of the reference route is regarded as completed in step S250.

The “immediately preceding waypoint” denotes the waypoint adjacent to the current temporary merge point and located closer to the vehicle M. In the example of FIG. 6, the waypoint Pw4 corresponds to the waypoint immediately preceding the waypoint (current temporary merge point) Pw5. This determination avoids repeating route determination for a waypoint once used as a temporary merge point, thereby restraining an increase in processing load during the parking route setting routine.

In response to determination that the waypoint immediately preceding the current temporary merge point has not been set as a temporary merge point (NO in step S250), the parking route setting routine proceeds to step S252. In step S252, the parking route setting unit 300 maintains the starting point and sets the immediately preceding waypoint as a new temporary merge point. Thereafter, the parking route setting unit 300 returns to step S160 and executes the operation in step S160 and subsequent operations.

That is, when execution of route-candidate setting with one of the reference points being set as a temporary merge point results in a distance between the temporary merge point and the end point of a parking route candidate selected by the route setting being greater than or equal to the first threshold (NO in step S200), the parking route setting unit 300 attempts route-candidate setting again, successively setting each preceding waypoint (Pw4, Pw3, Pw2, Pw1) as a new temporary merge point.

Specifically, in the example of FIG. 6, after attempting route-candidate setting with the reference point Pw5 as the temporary merge point, the parking route setting unit 300 successively sets each of the waypoints Pw4, Pw3, Pw2, and Pw1 as a new temporary merge point attempts route-candidate setting until a parking route candidate is obtained for which the distance calculated in step S200 becomes less than the first threshold (YES in step S200).

Execution of route-candidate setting for each waypoint while stepping back one waypoint at a time from the reference point Pw5 as the temporary merge point enables easier setting of a parking route that earlier merges the automatic parking start point into the reference route and has a smaller difference from the reference route.

In response to determination that the waypoint immediately preceding the current temporary merge point has already been set as a temporary merge point or no such preceding waypoint exists (YES in step S250), the reference route setting routine proceeds to step S260.

In step S260, the parking route setting unit 300 determines whether route-candidate setting has been completed with the last reference point set as the temporary merge point. In other words, the parking route setting unit 300 determines whether route-candidate setting has been attempted for all the waypoints on the reference route.

In response to determination that route-candidate setting has not been completed with the last reference point set as the temporary merge point (NO in step S260), the reference route setting routine proceeds to step S262.

In step S262, the parking route setting unit 300 maintains the starting point and sets the next reference point as a new temporary merge point. Following the operation in step S262, the parking route setting unit 300 returns to step S160, and executes the operation in step S160 and subsequent operations.

Specifically, in the example of FIG. 6, after attempting route-candidate setting with the waypoint Pw1 as the temporary merge point (YES in step S250), the parking route setting unit 300 attempts route-candidate setting with the waypoint Pw7, which is the next reference point after the reference point Pw5, as the new temporary merge point. Then, the parking route setting unit 300 attempts route-candidate setting while setting the waypoints Pw6, Pw11, Pw10, Pw9, Pw8, Pw15, Pw14, Pw13, and Pw12 as temporary merge points until a parking route candidate is obtained for which the distance calculated in step S200 becomes less than the threshold (YES in step S200).

Otherwise in response to determination that route-candidate setting has been completed with the last reference point set as the temporary merge point (YES in step S260), that is, when route-candidate setting has been attempted for all the waypoints on the reference route, the parking route setting routine proceeds to step S270.

In step S270, the parking route setting unit 300 determines whether there are one or more parking route candidates temporarily stored in the memory 320.

In response to determination that there are one or more parking route candidates temporarily stored in the memory 320 (YES in step S270), the parking route setting unit 300 selects, from the parking route candidates, a parking route candidate, and adapts the selected parking route candidate as the parking route from the starting point to the corresponding temporary merge point in step S280; the selected parking route candidate has the smallest distance between the end point of the selected parking route candidate and the corresponding temporary merge point in all the parking route candidates. After the operation in step S280, the parking route setting unit 300 returns to step S220 and executes the operation in step S220 and the subsequent operations.

Otherwise, in response to determination that no parking route candidate exists temporarily stored in the memory 320 (NO in step S270), the parking route setting unit 300 terminates the parking route setting routine with a result that no adoptable parking route exists in step S282.

The parking route setting unit 300 of the automatic parking system 10 according to the exemplary embodiment is configured to set a parking route for the vehicle M using a neutral point located on the reference route as a temporary merge point to the reference route. This configuration enables the vehicle M to merge into the reference route through the neutral point with a neutral steering angle.

Compared with a configuration that determines a merge point into the reference route solely by the vehicle's heading angle relative to the reference route, this configuration of the automatic parking system 10 according to the exemplary embodiment makes it possible to suppress destabilization of vehicle motion during parking.

Additionally, compared with a configuration that sets, as the temporary merge point, a waypoint with a leftward or rightward steering angle, this configuration of the automatic parking system 10 according to the exemplary embodiment enables the vehicle M, which has reached the temporary merge point on the reference route, to easily steer in either left or right direction, making it possible to suppress restriction of the traveling direction of the vehicle M on the subsequent portion of the parking route from the temporary merge point.

The parking route setting unit 300 of the automatic parking system 10 according to the exemplary embodiment is configured to determine whether a difference between a parking route set with a first waypoint on the reference route as a temporary merge point to the reference route and the reference route is greater than or equal to a preset threshold distance. The parking route setting unit 300 is configured to reset a new parking route with a second waypoint on the reference route, which is different from the first waypoint and closer to the vehicle M than the first waypoint, in response to determination that the difference between the parking route set with the first waypoint on the reference route as the temporary merge point to the reference route and the reference route is greater than or equal to the preset threshold distance.

This configuration therefore enables the vehicle M to merge earlier into the reference route from the automatic parking start point of the vehicle M, and makes a parking route with a smaller difference from the reference route likely to be set.

Additionally, when determining that route setting has already been attempted with the second waypoint as the temporary merge point to the reference route, the parking route setting unit 300 is configured not to perform route setting again for the second waypoint and instead perform route setting with another waypoint not yet attempted as the temporary merge point. This configuration avoids repeated route setting for the same waypoint, thus restraining an increase in processing load during the parking route setting routine.

When the distance between the vehicle M and the closest neutral point is less than the allowable distance, the parking route setting unit 300 is configured not to adopt a parking route candidate set using the closest neutral point as the temporary merge point, and instead generate a parking route candidate using a waypoint whose distance from the vehicle M is greater or equal to the allowable distance as the temporary merge point. This configuration prevents sudden steering when the vehicle M merges from the automatic parking start point Pst into the reference route.

### Other Embodiments and Modifications

In response to determination that the waypoint immediately preceding the current temporary merge point has not been set as a temporary merge point (NO in step S250), the parking route setting unit 300 sets the immediately preceding waypoint as the new temporary merge point in step S252. The present disclosure is however not limited to this configuration.

Specifically, in response to the negative determination in step S250, the parking route setting unit 300 may set, as the new temporary merge point, a waypoint located two or more positions prior to the current temporary merge point. This modification achieves the same effects as those of the exemplary embodiment.

Additionally, this configuration, which selects a waypoint closer to the vehicle M than the immediately preceding waypoint as the temporary merge point, makes a parking route, which merges from the automatic start point into the reference route earlier, more likely to be set.

In response to determination that the waypoint immediately preceding the current temporary merge point has already been set as a temporary merge point (YES in step S250), the parking route setting unit 300 does not attempt route-candidate setting again with the immediately preceding waypoint as the temporary merge point. The present disclosure is however not limited to this configuration.

Specifically, the parking route setting unit 300 may attempt route-candidate setting again using the immediately preceding waypoint as the temporary merge point.

In response to determination that route-candidate setting has not been completed with the last reference point set as the temporary merge point (NO in step S260), the parking route setting unit 300 sets the next reference point as the new temporary merge point in step S262. The present disclosure is however not limited to this configuration. Specifically, the present disclosure may set, as the temporary merge point, one of the waypoints that is not the reference points.

In step S142, the parking route setting unit 300 of the exemplary embodiment selects, as the reference points, neutral points at each of which the steering angle is neutral. The present disclosure is however not limited to this configuration.

Specifically, the parking route setting unit 300 need not select one or more neutral points as the reference points. In this modification, the parking route setting unit 300 may be configured to reset a parking route with a second waypoint as the temporary merge point, which is different from the first waypoint and located closer to the vehicle M. This enables the vehicle M to merge earlier into the reference route from the automatic parking start point of the vehicle M, and makes a parking route with a smaller difference from the reference route likely to be set.

In response to determination that the distance between the vehicle M and the reference route is less than the threshold (NO in step S144), the parking route setting unit 300 does not select, as one of the reference points, one of the multiple waypoints on the reference route, which is separated from the vehicle M by at least the predetermined allowable distance. The present disclosure is however not limited to this configuration.

Specifically, even if the distance between the vehicle M and the reference route is less than the threshold (NO in step S144), the parking route setting unit 300 may select, as one of the reference points, one of the multiple waypoints on the reference route, which is separated from the vehicle M by at least the predetermined allowable distance. This configuration prevents abrupt steering when merging from the automatic parking start point Pst into the reference route.

In response to determination that the distance is greater than or equal to the first threshold (NO in step S200), the parking route setting unit 300 executes the operations in steps S230 to S282. The present disclosure is however not limited to this configuration.

Specifically, the parking route setting unit 300 may not execute the operations in steps S230 to S282. Because this modification, which uses one of the neutral points as the temporary merge point, enables the vehicle M to merge into the reference route with a neutral steering angle, thereby suppressing destabilization of vehicle motion. This modification additionally suppresses restriction of the traveling direction on the subsequent portion of the parking route.

The automatic parking systems 10 and their parking methods according to the present disclosure can be implemented by a dedicated computer including a memory and a processor programmed to perform one or more functions embodied by one or more computer programs.

The automatic parking systems 10 and their parking methods according to the present disclosure can also be implemented by a dedicated computer including a processor comprised of one or more dedicated hardware logic circuits.

The automatic parking systems 10 and their parking methods according to the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

The present disclosure is not limited to the above embodiments, and can be implemented by various configurations within the scope of the present disclosure. For example, technical features included in the embodiments, which correspond to technical features included in the exemplary aspects described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiments, which are not described as essential elements in the specification, can be omitted as necessity arises.

The following describes features of the present disclosure.

### [First Feature]

A first feature of the present disclosure provides an automatic parking system for parking an automatically traveling vehicle. The automatic parking system includes a vehicle state detection unit configured to detect a traveling state of the vehicle, the traveling state including at least a position of the vehicle and a steering angle of the vehicle. The automatic parking system includes a reference route storage unit configured to store a reference route that is comprised of multiple waypoints at each of which a corresponding traveling state of the vehicle detected during traveling of the vehicle by a driver's driving to a target point is associated. The automatic parking system includes a parking route setting unit configured to set a parking route from an automatic parking start point to the target point using at least one waypoint included in the multiple waypoints as a temporary merge point to the reference route. The at least one waypoint is at least one neutral point at which a steering angle of the vehicle is neutral. The automatic parking system includes a vehicle control unit configured to control the vehicle so as to cause the vehicle to travel along the parking route.

### [Second Feature]

In a second feature of the present disclosure, which depends from the first feature, the at least one neutral points comprises plural neutral points, one of the plural neutral points located closest to the vehicle being defined as a closest neutral point. The parking route setting unit is configured to determine whether a distance between the closest neutral point and the vehicle is less than a predetermined allowable distance, and adopt a candidate for the parking route that is set using a selected one of the multiple waypoints other than the closest neutral point as the temporary merge point to the reference route in response to determination that the distance between the closest neutral point and the vehicle is less than the predetermined allowable distance. A distance of the selected one of the multiple points other than the closest neutral point to the vehicle is greater than or equal to the predetermined allowable distance.

### [Third Feature]

A third feature of the present disclosure provides an automatic parking system for parking an automatically traveling vehicle. The automatic parking system includes a vehicle state detection unit configured to detect a traveling state of the vehicle, the traveling state including at least a position of the vehicle and a steering angle of the vehicle. The automatic parking system includes a reference route storage unit configured to store a reference route that is comprised of multiple waypoints at each of which a corresponding traveling state of the vehicle detected during traveling of the vehicle by a driver's driving to a target point is associated. The multiple waypoints include a first waypoint, a second waypoint, and a third waypoint, the first, second, and third waypoints being different from one another, and the second waypoint is located closer to the vehicle than the first waypoint is. The automatic parking system includes a parking route setting unit configured to set a parking route from an automatic parking start point to the target point using the first waypoint as a temporary merge point to the reference route. The first waypoint is a neutral point at which a steering angle of the vehicle is neutral, the parking route being arranged to merge the reference route at the first waypoint as the temporary merge point. The automatic parking system includes a vehicle control unit configured to control the vehicle so as to cause the vehicle to travel along the parking route. The parking route setting unit is configured to determine whether a difference between (i) the parking route set using the first waypoint as the temporary merge point to the reference route and (ii) the reference route is greater than or equal to a threshold distance. The parking route setting unit is configured to reset the parking route using the second waypoint or the third waypoint as the temporary merge point to the reference route in response to determination that the difference between (i) the parking route set using the first waypoint as the temporary merge point to the reference route and (ii) the reference route is greater than or equal to the threshold distance.

### [Fourth Feature]

In a fourth feature of the present disclosure, which depends from the third feature, the parking route setting unit is configured to determine whether parking-route setting using the second waypoint as the temporary merge point to the reference route has already been attempted. The parking route setting unit is configured to reset the parking route using the third waypoint as the temporary merge point to the reference route in response to determination that (i) parking-route setting using the second waypoint as the temporary merge point to the reference route has already been attempted and (ii) parking-route setting using the third waypoint as the temporary merge point has not been attempted.

### [Fifth Feature]

In a fifth feature of the present disclosure, which depends from the third feature, the multiple waypoints include plural neutral points at each of which the steering angle of the vehicle is neutral. One of the plural neutral points located closest to the vehicle is defined as a closest neutral point. The parking route setting unit is configured to determine whether a distance between the closest neutral point and the vehicle is less than a predetermined allowable distance. The parking route setting unit is configured to adopt an additional parking route for the parking route that is set using a selected one of the multiple waypoints other than the closest neutral point as the temporary merge point to the reference route in response to determination that the distance between the closest neutral point and the vehicle is less than the predetermined allowable distance. A distance of the selected one of the multiple points other than the closest neutral point to the vehicle is greater than or equal to the predetermined allowable distance.

1. An automatic parking system for parking an automatically traveling vehicle, the automatic parking system comprising:
a vehicle state detection unit configured to detect a traveling state of the vehicle, the traveling state including at least a position of the vehicle and a steering angle of the vehicle;
a reference route storage unit configured to store a reference route that is comprised of multiple waypoints at each of which a corresponding traveling state of the vehicle detected during traveling of the vehicle by a driver's driving to a target point is associated;
a parking route setting unit configured to set a parking route from an automatic parking start point to the target point using at least one waypoint included in the multiple waypoints as a temporary merge point to the reference route, the at least one waypoint being at least one neutral point at which a steering angle of the vehicle is neutral; and
a vehicle control unit configured to control the vehicle so as to cause the vehicle to travel along the parking route.

2. The automatic parking system according to claim 1, wherein:
the at least one neutral points comprises plural neutral points, one of the plural neutral points located closest to the vehicle being defined as a closest neutral point; and
the parking route setting unit is configured to:
determine whether a distance between the closest neutral point and the vehicle is less than a predetermined allowable distance; and
adopt a candidate for the parking route that is set using a selected one of the multiple waypoints other than the closest neutral point as the temporary merge point to the reference route in response to determination that the distance between the closest neutral point and the vehicle is less than the predetermined allowable distance, a distance of the selected one of the multiple points other than the closest neutral point to the vehicle being greater than or equal to the predetermined allowable distance.

3. An automatic parking system for parking an automatically traveling vehicle, the automatic parking system comprising:
a vehicle state detection unit configured to detect a traveling state of the vehicle, the traveling state including at least a position of the vehicle and a steering angle of the vehicle;
a reference route storage unit configured to store a reference route that is comprised of multiple waypoints at each of which a corresponding traveling state of the vehicle detected during traveling of the vehicle by a driver's driving to a target point is associated, the multiple waypoints including a first waypoint, a second waypoint, and a third waypoint, the first, second, and third waypoints being different from one another, the second waypoint being located closer to the vehicle than the first waypoint is;
a parking route setting unit configured to set a parking route from an automatic parking start point to the target point using the first waypoint as a temporary merge point to the reference route, the first waypoint being a neutral point at which a steering angle of the vehicle is neutral, the parking route being arranged to merge the reference route at the first waypoint as the temporary merge point; and
a vehicle control unit configured to control the vehicle so as to cause the vehicle to travel along the parking route, wherein:
the parking route setting unit is configured to:
determine whether a difference between (i) the parking route set using the first waypoint as the temporary merge point to the reference route and (ii) the reference route is greater than or equal to a threshold distance; and
reset the parking route using the second waypoint or the third waypoint as the temporary merge point to the reference route in response to determination that the difference between (i) the parking route set using the first waypoint as the temporary merge point to the reference route and (ii) the reference route is greater than or equal to the threshold distance.

4. The automatic parking system according to claim 3, wherein:
the parking route setting unit is configured to:
determine whether parking-route setting using the second waypoint as the temporary merge point to the reference route has already been attempted; and
reset the parking route using the third waypoint as the temporary merge point to the reference route in response to determination that (i) parking-route setting using the second waypoint as the temporary merge point to the reference route has already been attempted and (ii) parking-route setting using the third waypoint as the temporary merge point has not been attempted.

5. The automatic parking system according to claim 3, wherein:
the multiple waypoints include plural neutral points at each of which the steering angle of the vehicle is neutral, one of the plural neutral points located closest to the vehicle being defined as a closest neutral point; and
the parking route setting unit is configured to:
determine whether a distance between the closest neutral point and the vehicle is less than a predetermined allowable distance; and
adopt an additional parking route for the parking route that is set using a selected one of the multiple waypoints other than the closest neutral point as the temporary merge point to the reference route in response to determination that the distance between the closest neutral point and the vehicle is less than the predetermined allowable distance, a distance of the selected one of the multiple points other than the closest neutral point to the vehicle being greater than or equal to the predetermined allowable distance.
